(19) United States
(12) Patent Application Publication
(10) Pub. No.: US 2026/0267601 A1
(43) Pub. Date: Sep. 10, 2026

(54) METHOD AND APPARATUS FOR PROCESSING VOICE COMMANDS BASED ON OPTICAL CHARACTER RECOGNITION (OCR)

(71) Applicants: HYUNDAI MOTOR COMPANY, Seoul (KR); KIA CORPORATION, Seoul (KR)

(72) Inventor: Sung Soo Park, Seoul (KR)

(73) Assignees: HYUNDAI MOTOR COMPANY, Seoul (KR); KIA CORPORATION, Seoul (KR)

(21) Appl. No.: 19/324,029

(22) Filed: Sep. 9, 2025

(30) Foreign Application Priority Data
Mar. 6, 2025 (KR) 10-2025-0028771

(51) Int. Cl. G06F 3/16; G06V 30/14; G06V 30/30; G10L 15/08; G10L 15/22; G10L 15/24

(52) U.S. Cl. CPC G06F 3/167; G06V 30/1444; G06V 30/30; G10L 15/08; G10L 15/22; G10L 15/24; G10L 2015/088; G10L 2015/223

(57) ABSTRACT

A method for processing voice commands of a user based on a display screen displayed to the user including performing optical character recognition (OCR) on the display screen to obtain texts displayed on the display screen and respective positions of the texts. The method also includes generating screen keyword information including words and sentences included in utterances of the user, based on the texts and the respective positions of the texts. The method additionally includes determining a screen domain based on the screen keyword information, where the screen domain is a command domain corresponding to the display screen, from among a plurality of command domains. The method further includes generating commands corresponding to the utterances of the user based on the screen keyword information and the screen domain and process voice commands of the user based on the generated commands.

### CROSS-REFERENCE TO RELATED APPLICATION

The present application claims the benefit of and priority to Korean Patent Application No. 10-2025-0028771, filed on Mar. 6, 2025, the entire contents of which are hereby incorporated herein by reference.

### TECHNICAL FIELD

The present disclosure relates to a method and an apparatus for processing voice commands based on optical character recognition (OCR).

### BACKGROUND

The statements in this Background section merely provide background information related to the present disclosure and do not necessarily constitute prior art.

A voice command system is a technology by which a user may give commands to a device or software through voice. The voice command system performs speech recognition to convert the voice of the user into text. The voice command system then analyzes the converted text to control device or software to perform a task in accordance with an intention of the user. Such voice command systems are used in a variety of devices such as automobiles, smartphones, home appliances, and the like, and help the user control the device without using their hands.

A conventional voice command system may process only predetermined commands, and there is a problem in that utterance of the user that is not included in the predetermined commands is not processed or the task that is not intended by the user is performed.

FIG. 1 and FIG. 2 each show an example of a music platform screen provided in a vehicle. In FIG. 1, the texts in the box indicated by the white dotted line correspond to predetermined commands. Referring to FIG. 1, for example, when the user utters “Today's Top 100” as displayed on the music platform screen, the voice command system performs a task of showing or playing a list of the top 100 popular songs.

On the other hand, in FIG. 2, the texts in the box indicated by the white dotted line represent a list of song titles, which are texts that may vary depending on the situation. The song titles included in the song list may vary depending on the situation and may not be pre-stored as commands. Therefore, referring to FIG. 2, even if the user utters the song title “spring, summer, fall, winter” to play the first song, there is a problem that the conventional voice command systems do not play that song or perform a destination search that is not intended by the user at all.

### SUMMARY

Embodiments of the present disclosure provide a method and an apparatus capable of processing voice commands that are not predefined, by analyzing text information in a screen to generate new commands.

The technical objects of the present disclosure are not limited to those described above. Other technical objects not mentioned above should be more clearly understood by those having ordinary skill in the art from the descriptions given below.

According to an embodiment of the present disclosure, a computer-implemented method for processing voice commands of a user based on a display screen displayed to the user is provided. The method includes performing OCR on the display screen to obtain texts displayed on the display screen and respective positions of the texts. The computer-implemented method also includes generating screen keyword information including words and sentences included in utterances of the user, based on the texts and the respective positions of the texts. The computer-implemented method additionally includes determining a screen domain based on the screen keyword information, where the screen domain is a command domain corresponding to the display screen, from among a plurality of command domains. The computer-implemented method further includes generating commands corresponding to the utterances of the user based on the screen keyword information and the screen domain and processing voice commands of the user based on the generated commands.

According to another embodiment of the present disclosure, an apparatus for processing voice commands of a user based on a display screen displayed to the user is provided. The apparatus includes at least one memory storing computer-readable instructions. The apparatus also includes at least one processor configured to execute the computer-readable instructions to: perform OCR on the display screen to obtain texts displayed on the display screen and respective positions of the texts; generate screen keyword information including words and sentences included in utterances of the user, based on the texts and the respective positions of the texts; determine a screen domain based on the screen keyword information, where the screen domain is a command domain corresponding to the display screen, from among a plurality of command domains; generate commands corresponding to the utterances of the user based on the screen keyword information and the screen domain; and process voice commands of the user based on the generated commands.

According to yet another embodiment, a non-transitory computer-readable medium or media storing computer-readable instructions is provided. The computer-readable instructions, when executed by at least one processor, cause the at least one processor to: perform OCR on a display screen to obtain texts displayed on the display screen to a user and respective positions of the texts; generate screen keyword information comprising words and sentences included in utterances of the user, based on the texts and the respective positions of the texts; determine a screen domain based on the screen keyword information, wherein the screen domain is a command domain corresponding to the display screen, from among a plurality of command domains; generate commands corresponding to the utterances of the user based on the screen keyword information and the screen domain; and process voice commands of the user based on the generated commands.

According to an embodiment of the disclosure, there is an effect in that voice commands that are not predefined may be processed, by analyzing a display screen to dynamically generate new commands.

According to an embodiment of the disclosure, there is an effect in that voice commands may be processed in a manner aligned with the user's intended utterance, by dynamically generating new commands based on the display screen.

The technical effects of the present disclosure are not limited to the technical effects described above. Other technical effects not mentioned herein should be more clearly understood to those having ordinary skill in the art to which the present disclosure pertains from the description below.

### BRIEF DESCRIPTION OF THE DRAWINGS

FIG. 1 and FIG. 2 each show an example of a music platform screen provided in a vehicle.

FIG. 3 is a block diagram schematically showing a voice command system according to an embodiment of the present disclosure.

FIG. 4 shows an example of a result of performing OCR on the screen of FIG. 2 and screen keyword information generated based on the OCR performance result according to an embodiment of the present disclosure.

FIG. 5 is an example diagram showing an example of an embedding space for classifying command domains to which screen keywords belong, in an embodiment of the present disclosure.

FIG. 6 shows an example of a command generated based on the screen keyword information of FIG. 4 and the screen domain of FIG. 5 according to an embodiment of the present disclosure.

FIG. 7 shows an example of text dynamically displayed with an ellipsis on the music platform screen according to an embodiment of the present disclosure.

FIG. 8 is an example diagram showing a process of iteratively performing OCR to obtain a plurality of character strings, so as to obtain a full character string of the dynamic text shown in FIG. 7 according to an embodiment of the present disclosure.

FIGS. 9-11 are each an example diagram showing a process of concatenating the plurality of character strings obtained in the embodiment of FIG. 8 to generate a full character string according to an embodiment of the present disclosure.

FIG. 12 is a flowchart for setting a process of processing a user's voice command based on a display screen by a voice command system according to an embodiment of the present disclosure.

FIG. 13 is a flowchart for describing obtaining a full character string of in the process of FIG. 12 according to an embodiment.

FIG. 14 is a block diagram schematically showing an example of a computing device that may be used to implement a method or apparatus according to an embodiment of the present disclosure.

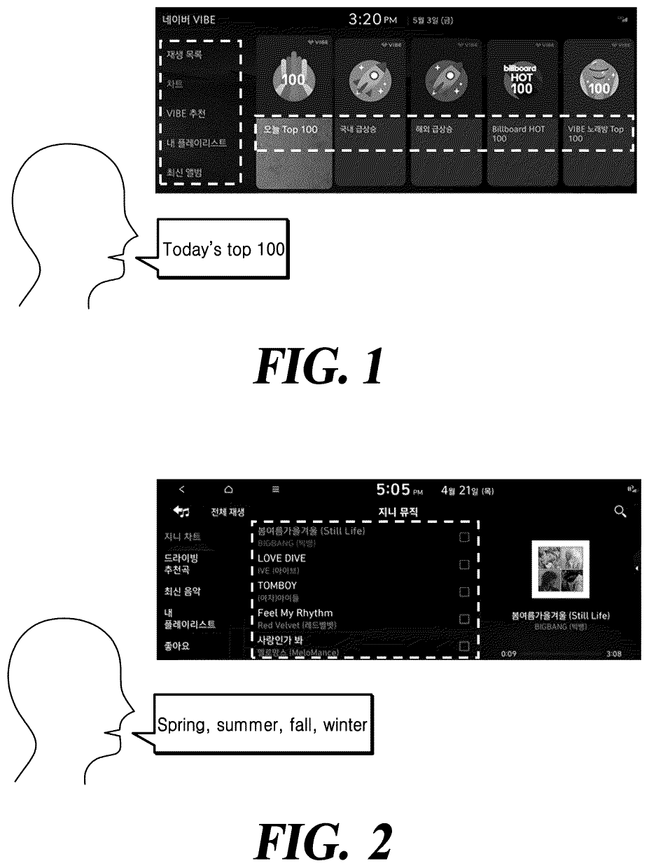

### DETAILED DESCRIPTION

Hereinafter, embodiments of the present disclosure are described in detail with reference to the accompanying drawings. In the following description, like reference numerals preferably designate like elements, even when the elements are shown in different drawings. Further, in the following description of embodiments, wherein it was determined that a detailed description of known functions and configurations would obscure the gist of the present disclosure, the detailed description thereof has been omitted for the purpose of clarity and for brevity.

Additionally, various terms such as first, second, A, B, (a), (b), etc., may be used herein merely to differentiate one component from the another. These terms not to imply or suggest the substances, order, or sequence of the constituent components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

The following detailed description, together with the accompanying drawings, is intended to describe embodiments of the present disclosure, and is not intended to represent the only embodiments in which the present disclosure may be practiced.

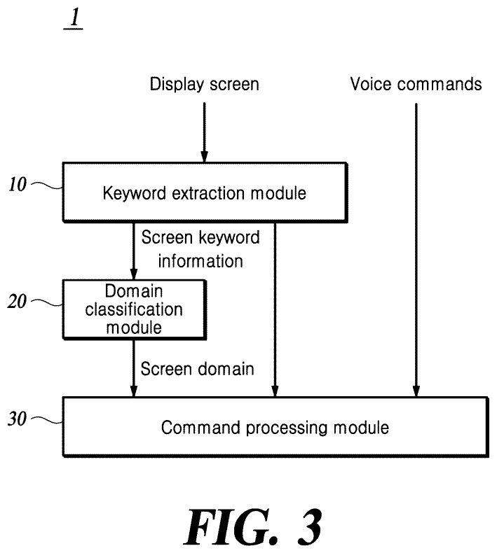

FIG. 3 is a block diagram schematically showing a voice command system according to an embodiment of the disclosure.

As shown in FIG. 3, the voice command system 1 may include a keyword extraction module 10, a domain classification module 20, and a command processing module 30. The voice command system 1 may be implemented in a form of an embedded device, a server, an electronic device in an autonomous driving system, or the like. All blocks shown in FIG. 3 are not necessarily essential components, and in other embodiments, some blocks included in the voice command system 1 may be added, changed, or deleted. In an embodiment, the components shown in FIG. 3 represent functionally distinct elements, and may be implemented in a form in which at least one component is integrated with at least one other component in an actual physical environment.

The keyword extraction module 10 may receive or otherwise process a screen currently being displayed from a display device, and may obtain screen keyword information including words and/or sentences that may be included in utterances of a user, based on the screen being displayed. The screen keyword information may include texts displayed on the screen and positions of those texts.

In an embodiment, the keyword extraction module 10 may extract texts in the screen and position coordinates thereof by performing optical character recognition (OCR) on the screen currently being displayed, and may generate screen keyword information based on the extracted texts and the position coordinates.

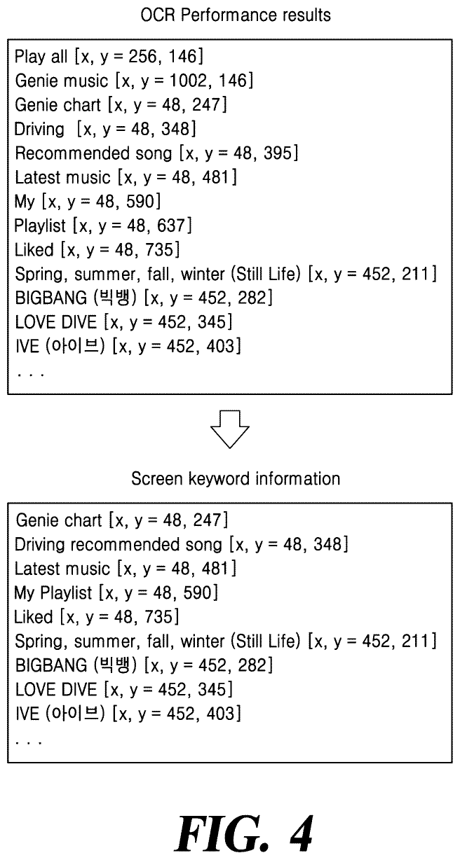

FIG. 4 shows an example of a result of performing OCR on the screen of FIG. 2 and screen keyword information generated based on the OCR performance result, according to an embodiment. Referring to the OCR performance result of FIG. 4, it may be seen that the texts displayed on the screen of FIG. 2 are extracted in units of lines or words. The keyword extraction module 10 may generate the screen keyword information including a plurality of keywords that may be included in the user's voice command, based on the OCR performance result.

The domain classification module 20 may receive the screen keyword information from the keyword extraction module 10, and may determine a domain to which the screen keywords belong, from among a plurality of command domains.

In one embodiment, the domain classification module 20 may use a user intent classifier that classifies the domains based on the embedding-based domain distances to determine the domain to which the screen keywords belong. For example, the domain classification module 20 may determine the domain, to which the screen keywords belong, by calculating embedding vectors corresponding to each of the screen keywords and calculating distances of the embedding vectors for each of the plurality of command domains in the embedding space.

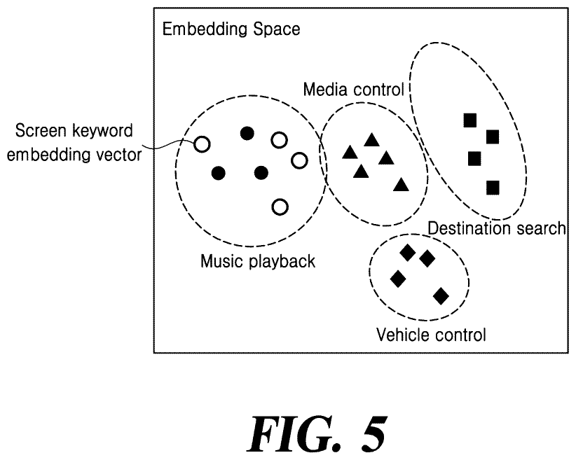

FIG. 5 is a diagram showing an example of an embedding space for classifying command domains to which screen keywords belong, according to an embodiment.

In FIG. 5, the black-filled dots represent embedding vectors corresponding to respective pre-stored commands. The circle-shaped dots represent embedding vectors belonging to a music playback domain, the triangle-shaped dots represent embedding vectors belonging to a media control domain, the square-shaped dots represent embedding vectors belonging to a destination search domain, and the diamond-shaped dots represent embedding vectors belonging to a vehicle control domain.

In addition, white dots in FIG. 5 represent embedding vectors corresponding to each of the screen keywords. For simplicity of the drawing, only a part of embedding vectors corresponding to the screen keywords displayed on the screen of FIG. 2 has been shown.

Referring to FIG. 5, the domain classification module 20 may calculate embedding vectors corresponding to each of the screen keywords, and may determine the domain to which the screen keywords belong, based on distances of the embedding vectors to each of the plurality of command domains in the embedding space. In FIG. 5, the screen keywords have the shortest distance to the music playback domain, and thus the music playback domain is determined as the instruction domain of the screen currently being displayed.

The command processing module 30 may generate commands corresponding to the utterances of the user, based on the screen keyword information received from the keyword extraction module 10 and a screen domain received from the domain classification module 20, and may process the generated commands.

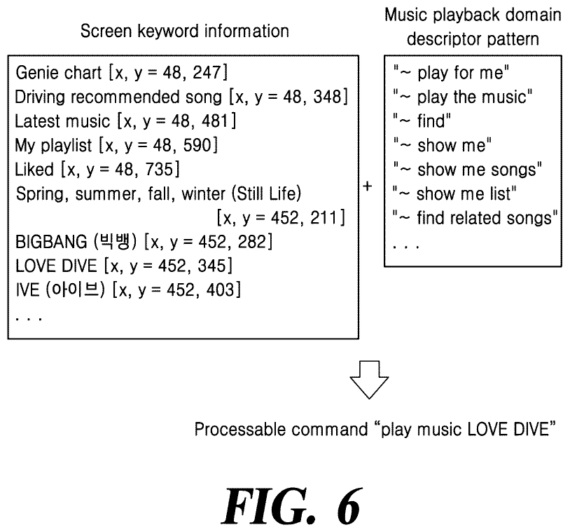

FIG. 6 shows an example of a command generated based on the screen keyword information of FIG. 4 and the screen domain of FIG. 5, according to an embodiment. In FIG. 6, the left list represents the screen keyword information, and the right list represents a descriptor pattern of the voice commands in the music playback domain.

When the user utters the command “play music LOVE DIVE”, the command processing module 30 checks whether there is a screen keyword included in the utterances of the user, and checks the descriptor pattern in the music playback domain to generate commands corresponding to the utterances of the user.

When the commands corresponding to the utterances of the user are generated, the command processing module 30 controls the peripheral so that the song “LOVE DIVE” of “IVE” is played on the music platform. Thus, the voice command system 1 may perform a task according to the user's intention even when the voice commands of the user are not included in the predetermined commands.

Hereinafter, some embodiments of the present disclosure are described in more detail.

In the case of texts that are difficult to be fully displayed on a single screen due to a long sentence length, such as a long song title, the texts may be displayed as dynamic text along with an ellipsis (e.g., abbreviation ( . . . )).

In a further embodiment of the present disclosure, the keyword extraction module 10 may obtain a full character string of the text dynamically displayed with the ellipsis. Korean characters are shown for illustrative purposes only; other languages may be used.

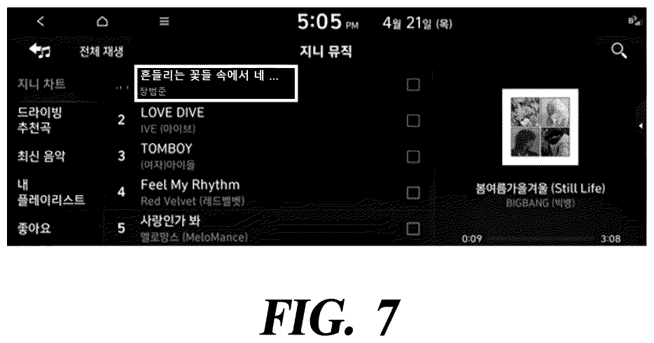

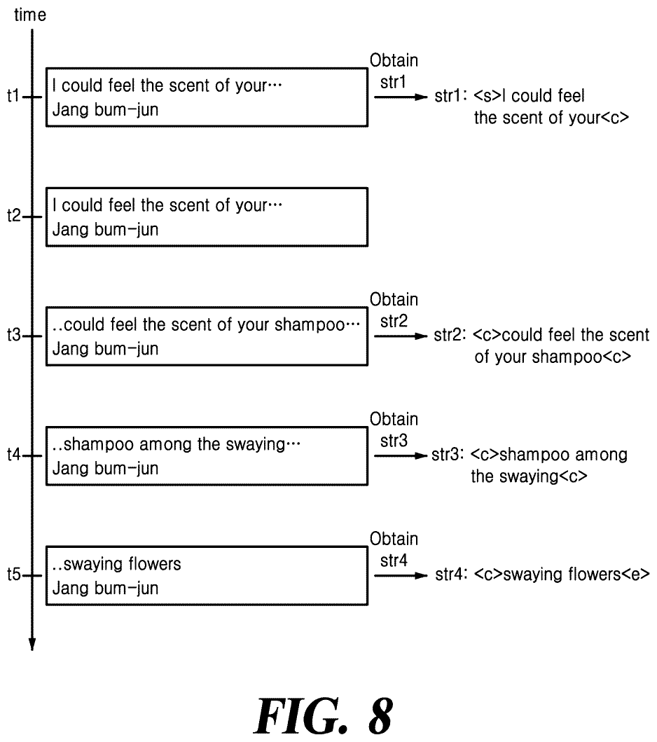

FIG. 7 shows an example of text dynamically displayed with an ellipsis ( . . . ) on the music platform screen. Referring to the white box in FIG. 7, it may be seen that the song title is long, so that the song titles are not fully displayed, but only partially displayed. The full sentence of the song title is “I could feel the scent of your shampoo among the swaying flowers (Korean: [symbol] [symbol] [symbol] ),” but only “I could feel the scent of your . . . (Korean: “ [symbol] [symbol] . . . )” is displayed on the current screen. Therefore, the full song title may not be obtained with only one OCR performance.

FIG. 8 is a diagram showing an example process of iteratively performing OCR to obtain a plurality of character strings, so as to obtain a full character string of the dynamic text shown in FIG. 7, according to an embodiment.

The keyword extraction module 10 may perform OCR at a preset time interval or any time interval. In the example of FIG. 8, it is assumed that OCR is performed at a preset time interval.

In addition, the keyword extraction module 10 may detect a region including dynamic text by recognizing a region in which the ellipsis is displayed on the screen. The keyword extraction module 10 may perform OCR only on the region including the dynamic text, thereby reducing an OCR operation amount and increasing a processing speed.

The keyword extraction module 10 obtains the first character string str1 by performing OCR on the region including the dynamic text at time point t1. In str1, <s> is a symbol indicating the start of the full character string, and <c> is a symbol indicating that there are other continuous character strings.

At time point t2, since there is no change in the region including the dynamic text, OCR is not performed.

At time point t3, since there is a change in the region including the dynamic text, OCR is performed, and a second character string str2 is obtained. Then, at time point t4, since there is also a change in the region including the dynamic text, OCR is performed, and the third character string str3 is obtained.

At time point t5, since there is also a change in the region including the dynamic text, OCR is performed, and the fourth character string str4 is obtained. In str4, <e> is a symbol indicating the end of the full character string. When the ellipsis is not included in the end of the sentence obtained by performing the OCR, the keyword extraction module 10 determines that the end of the statement has been reached, and does not perform the OCR anymore.

Finally, in the embodiment of FIG. 8, the keyword extraction module 10 may obtain four character strings str1 to str4.

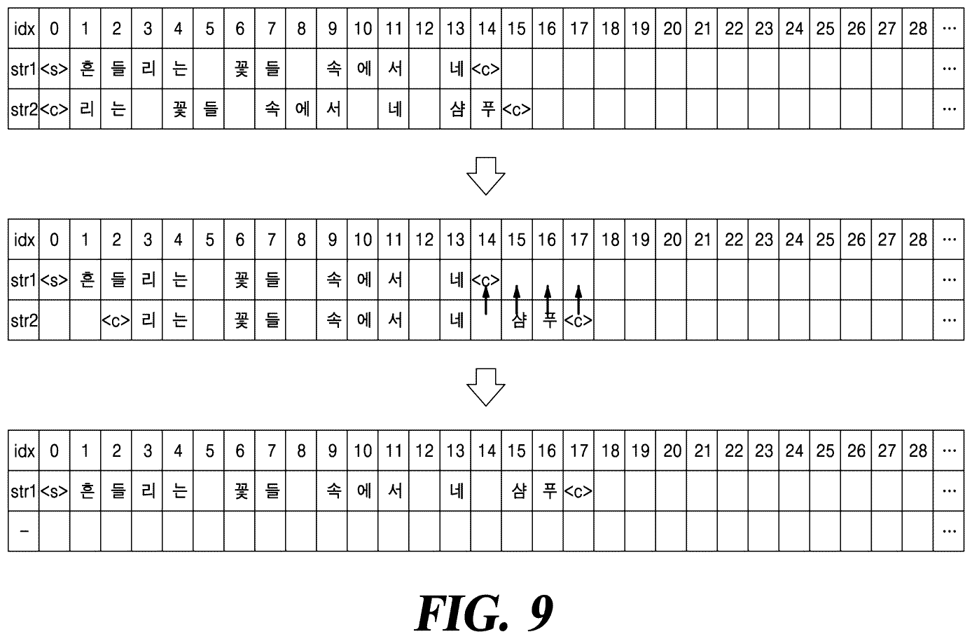

FIGS. 9-11 are each an example diagram showing a process of concatenating the plurality of character strings (str1 to str4) obtained in the embodiment of FIG. 8 to generate a full character string, according to an embodiment.

The keyword extraction module 10 generates the full character string based on the character string including <s>. Referring to FIG. 9, the keyword extraction module 10 compares str1, which is character string including <s>, with str2, which is next character string, to find an overlapping portion (“could feel the scent of your (Korean: [symbol] )”). The index of str2 is adjusted so that the indexes of the overlapping portions in str1 and str2 match. The characters located behind the overlapping portion in str2 (“shampoo<c> ( [symbol] c>)”) are copied to str1.

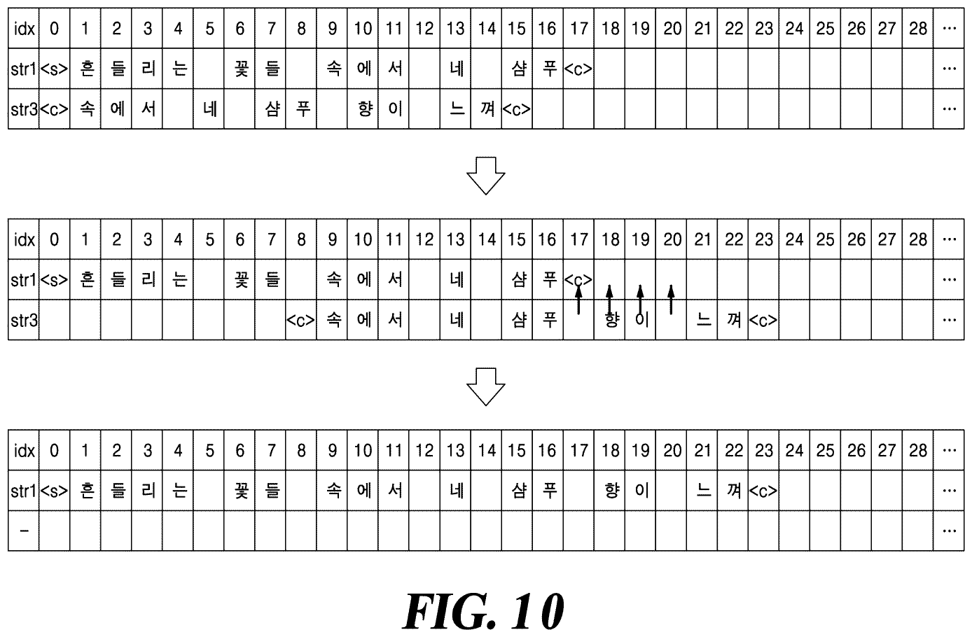

Next, referring to FIG. 10, the keyword extraction module 10 compares str1 with the next character string, str3, to find an overlapping portion (“shampoo among ( [symbol] )”). The index of str3 is adjusted so that the indexes of the overlapping portions in str1 and str3 match. The characters (“the swaying <c> ( [symbol] [symbol] <c>)”) located behind the overlapping portion in str3 are copied to str1.

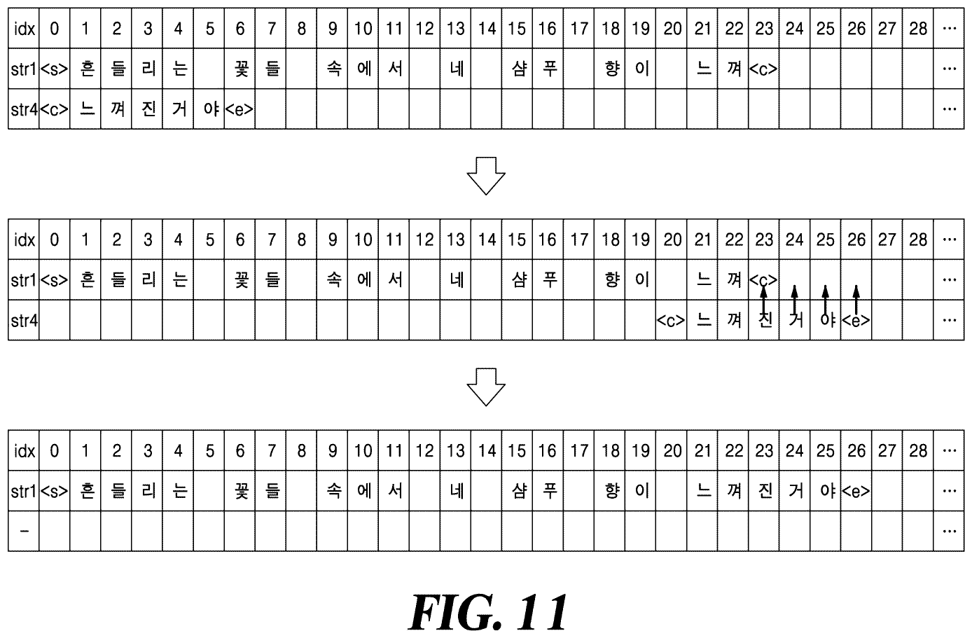

Finally, referring to FIG. 11, the keyword extraction module 10 compares str1 with the next string, str4, to find an overlapping portion (“swaying ( [symbol] )”). The index of str4 is adjusted so that the indexes of the overlapping portions in str1 and str4 match. The characters behind the overlapping portion in str4 (“flowers<e> ( [symbol] <e>)”) are copied to str1. Since str4 includes <e>indicating the end of the character string, the process of combining the plurality of character strings ends, and the full character string stored in str1 is output.

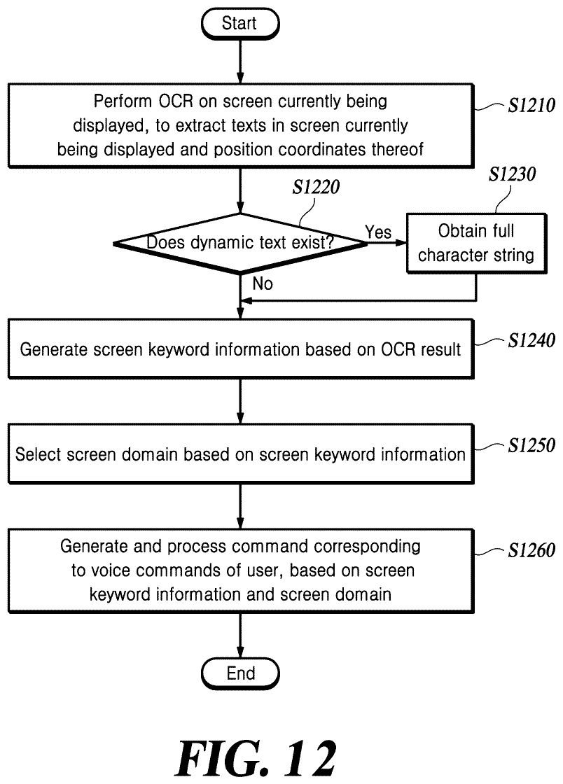

FIG. 12 is a flowchart of a process in which the voice command system 1 generates a new command based on a display screen and processes voice commands of a user, according to an embodiment.

In an operation S1210, the voice command system 1 performs OCR on the currently displayed screen to extract the texts included in the screen currently displayed to the user and the position coordinates thereof.

In an operation S1220, the voice command system 1 determines whether dynamic text exists on the currently displayed screen based on the OCR result. In an embodiment, the dynamic text means a text that the length of the text is so long that the full text may not be displayed on single screen and only a part of the full text is displayed together with an omission display (e.g., abbreviation ( . . . )), where the displayed content changes over time.

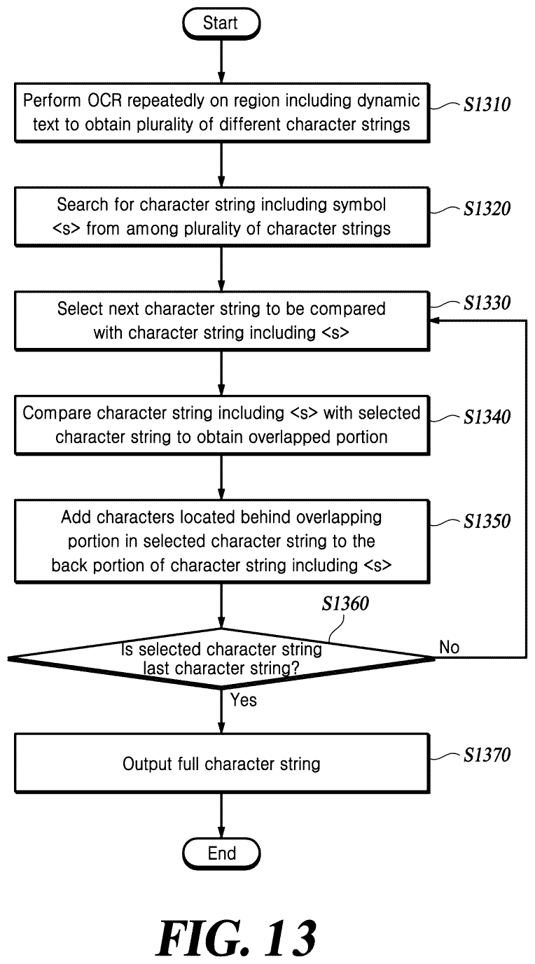

When the dynamic text exists (YES in the operation S1220), the voice command system 1 obtains the full character string constituting the dynamic text in an operation S1230. A process of obtaining the full character string of the dynamic text, according to an embodiment, is described in more detail below with reference to FIG. 13.

When the dynamic text does not exist (NO in the operation S1220), the voice command system 1 generates the screen keyword information based on the OCR result in an operation S1240. In an embodiment, the screen keyword information means the information including words and/or sentences that may be included in the utterances of the user when the user utters voice commands based on the screen displayed to the user.

In an operation S1250, the voice command system 1 selects the screen domain that is a domain for processing commands for the currently displayed screen, from among the plurality of command domains based on the screen keyword information. To determine the screen domain, the user intent classifier may be used that classifies the domains based on the embedding-based domain distances.

In an operation S1260, the voice command system 1 generates the commands corresponding to the voice commands of the user, based on the screen keyword information and the screen domain, and processes the voice commands of the user by controlling the device according to the generated commands.

FIG. 13 is a flowchart of a process of obtaining full character string of dynamic text that may be performed in the operation S1230 of FIG. 12, according to an embodiment.

In an operation S1310, the voice command system 1 iteratively performs OCR on the region including dynamic text on the screen to obtain the plurality of different character strings. In this case, any one of <s>, <c>, and <e> is added to both ends of each of the plurality of character strings. In an embodiment, <s> is a symbol indicating the start of character string, <c> is a symbol indicating that there are other continuous character strings, and <e> is a symbol indicating an end of character string.

In an operation S1320, the voice command system 1 searches for a character string including <s> from among the plurality of character strings, in order to sequentially complete the full character string from the front portion.

In an operation S1330, the voice command system 1 selects the next character string of the character string including <s> as a character string to be compared with the character string including <s>.

In an operation S1340, the voice command system 1 compares the character string including <s> with the selected character string to obtain an overlapped portion.

In an operation S1350, the voice command system 1 adds characters located behind the overlapping portion in the selected character string to the back portion of the character string including <s>.

In an operation S1360, the voice command system 1 determines whether the selected character string is the last character string by checking whether <e> is included in the selected character string. When the selected character string is not the last character string (NO in the operation S1360), the voice command system 1 returns to the operation S1330 to select the next character string of the selected character string as the character string to be compared with the character string including <s>.

When the selected character string is the last character string (YES in the operation S1360), the voice command system 1 proceeds to an operation S1370 to output the full character string because the full character string is recorded in the character string including <s>.

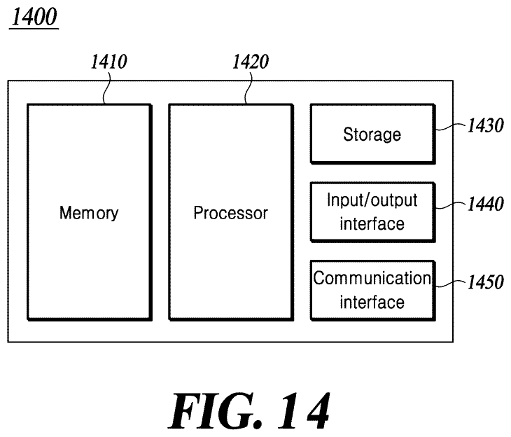

FIG. 14 is a block diagram schematically showing an example of a computing device that may be used to implement a method or apparatus according to the disclosure.

Computing device 1400 may include some or all of memory 1410, processor 1420, storage 1430, input/output interface 1440, and communication interface 1450. The computing device 1400 may structurally and/or functionally include at least a portion of a device in accordance with the disclosure. The computing device 1400 may be a stationary computing device such as desktop computer, server, or the like, as well as a mobile computing device such as laptop computer, smart phone, automotive electronic, or the like. The computing device 1400 may also be implemented with any specialized hardware accelerator capable of handling operations on an artificial intelligence model in an efficient manner. For example, the computing device 1400 may include a graphics processing unit (GPU), a tensor processing unit (TPU), or a neural processing unit (NPU).

The memory 1410 may store a program that causes the processor 1420 to perform a method or an operation according to various embodiments of the disclosure. For example, the program may include a plurality of computer-readable instructions executable by the processor 1420, and the method or operations described above may be performed by executing the plurality of instructions by the processor 1420. The memory 1410 may be a single memory or a plurality of memories. In this case, information required for performing the methods or operations according to various embodiments of the disclosure may be stored in the single memory or may be separately stored in the plurality of memories. When the memory 1410 is configured with the plurality of memories, the plurality of memories may be physically separated. The memory 1410 may include at least one of a volatile memory and a non-volatile memory. The volatile memory includes a static random access memory (SRAM), a dynamic random access memory (DRAM), or the like, and the non-volatile memory includes a flash memory or the like.

The processor 1420 may include at least one core capable of executing at least one instruction. The processor 1420 may execute instructions stored in the memory 1410. The processor 1420 may be a single processor or a plurality of processors.

The storage 1430 maintains stored data even when power supplied to the computing device 1400 is interrupted. For example, the storage 1430 may include the non-volatile memory, and may include a storage medium such as a magnetic tape, an optical disc, or a magnetic disk. The program stored in the storage 1430 may be loaded into the memory 1410 before being executed by the processor 1420. The storage 1430 may store a file written in a program language, and a program generated by a compiler or the like from the file may be loaded into the memory 1410. The storage 1430 may store data to be processed by the processor 1420 and/or data processed by the processors 1420.

The input/output interface 1440 may provide an interface with an input device such as a keyboard, mouse, or the like and/or an output device such as display device, printer, or the like. The user may trigger execution of the program by the processor 1420 through the input device, and/or check a processing result of the processor 1420 through the output device.

The communication interface 1450 may provide access to an external network. The computing device 1400 may communicate with other devices through the communication interface 1450.

Each element of the apparatus or method in accordance with embodiments of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an illustrative description of the technical idea of an embodiment of the present disclosure. In other words, those having ordinary skill in the art to which the present disclosure pertains would appreciate that various modifications and changes can be made without departing from essential features of an embodiment of the present disclosure. For example, the sequence illustrated in the flowcharts/timing charts can be changed and one or more operations of the operations can be performed in parallel. Thus, flowcharts/timing charts are not limited to the temporal order.

Although example embodiments of the present disclosure have been described for illustrative purposes, those having ordinary skill in the art should appreciate that various modifications, additions, and substitutions are possible, without departing from the idea and scope of the following claims. Therefore, example embodiments of the present disclosure have been described for the sake of brevity and clarity. The scope of the technical idea of the present disclosure is not limited by the illustrations. Accordingly, one of ordinary skill should understand that the scope of the present disclosure is not to be limited by the above explicitly described embodiments but by the claims and equivalents thereof.

What is claimed is:

1. A computer-implemented method for processing voice commands of a user based on a display screen displayed to the user, the method comprising:
performing optical character recognition (OCR) on the display screen to obtain texts displayed on the display screen and respective positions of the texts;
generating screen keyword information including words and sentences of utterances of the user, based on the texts and the respective positions of the texts;
determining a screen domain based on the screen keyword information, wherein the screen domain is a command domain corresponding to the display screen, from among a plurality of command domains;
generating commands corresponding to the utterances of the user based on the screen keyword information and the screen domain; and
processing voice commands of the user based on the generated commands.

2. The computer-implemented method of claim 1, wherein determining the screen domain comprises:
calculating a plurality of embedding vectors corresponding to each of a plurality of keywords included in the screen keyword information; and
determining the screen domain based on a domain distance of the plurality of embedding vectors to each of the plurality of command domains.

3. The computer-implemented method of claim 1, wherein generating commands corresponding to the utterances of the user comprises:
selecting a keyword from among a plurality of keywords included in the screen keyword information;
selecting a descriptor pattern corresponding to the utterances of the user from among descriptor patterns included in the screen domain; and
generating commands corresponding to the utterances of the user based on the selected keyword and the selected descriptor pattern.

4. The computer-implemented method of claim 1, wherein obtaining the texts displayed on the display screen and respective positions of the texts includes:
based on determining that dynamic text comprising an ellipsis is displayed on the display screen,
iteratively performing OCR to obtain a plurality of character strings for the dynamic text, and
concatenating the plurality of character strings to generate a full character string of the dynamic text.

5. The computer-implemented method of claim 4, wherein iteratively performing OCR includes performing OCR only on a region in which the dynamic text is comprised in the display screen.

6. The computer-implemented method of claim 4, wherein concatenating the plurality of character strings includes concatenating the plurality of character strings based on overlapping portions between two consecutive character strings among the plurality of character strings.

7. An apparatus for processing voice commands of a user based on a display screen displayed to the user, the apparatus comprising:
at least one memory storing computer-readable instructions; and
at least one processor,
wherein the at least one processor is configured to execute the computer-readable instructions to:
perform optical character recognition (OCR) on the display screen to obtain texts displayed on the display screen and respective positions of the texts,
generate screen keyword information comprising words and sentences included in utterances of the user, based on the texts and the respective positions of the texts,
determine a screen domain based on the screen keyword information, wherein the screen domain is a command domain corresponding to the display screen, from among a plurality of command domains,
generate commands corresponding to the utterances of the user based on the screen keyword information and the screen domain, and
process voice commands of the user based on the generated commands.

8. The apparatus of claim 7, wherein the at least one processor is further configured to:
calculate a plurality of embedding vectors corresponding to each of a plurality of keywords included in the screen keyword information; and
determine the screen domain based on domain distances of the plurality of embedding vectors with respect to each of the plurality of command domains.

9. The apparatus of claim 7, wherein the at least one processor is further configured to:
select a keyword from among a plurality of keywords included in the screen keyword information;
select a descriptor pattern corresponding to the utterances of the user from among descriptor patterns included in the screen domain; and
generate commands corresponding to the utterances of the user based on the selected keyword and the selected descriptor pattern.

10. The apparatus of claim 7, wherein the at least one processor is further configured to, based on determining that dynamic text comprising an ellipsis is displayed on the display screen, obtain a full character string of the dynamic text by iteratively performing OCR to obtain a plurality of character strings for the dynamic text, and concatenate the plurality of character strings.

11. The apparatus of claim 10, wherein the at least one processor is configured to iteratively perform OCR only on a region in which the dynamic text is comprised in the display screen.

12. The apparatus of claim 10, wherein the at least one processor is configured to concatenate the plurality of character strings based on overlapping portions between two consecutive character strings among the plurality of character strings.

13. A non-transitory computer-readable medium or media storing computer-readable instructions that, when executed by at least one processor, cause the at least one processor to:
perform OCR on a display screen to obtain texts displayed on the display screen to a user and respective positions of the texts;
generate screen keyword information comprising words and sentences included in utterances of the user, based on the texts and the respective positions of the texts;
determine a screen domain based on the screen keyword information, wherein the screen domain is a command domain corresponding to the display screen, from among a plurality of command domains;
generate commands corresponding to the utterances of the user based on the screen keyword information and the screen domain; and
process voice commands of the user based on the generated commands.

14. The non-transitory computer-readable medium or media claim 13, wherein the computer-readable instructions, when executed by the at least one processor, cause the at least one processor to:
calculate a plurality of embedding vectors corresponding to each of a plurality of keywords included in the screen keyword information; and
determine the screen domain based on domain distances of the plurality of embedding vectors with respect to each of the plurality of command domains.

15. The non-transitory computer-readable medium or media claim 13, wherein the computer-readable instructions, when executed by the at least one processor, cause the at least one processor to:
select a keyword from among a plurality of keywords included in the screen keyword information;
select a descriptor pattern corresponding to the utterances of the user from among descriptor patterns included in the screen domain; and
generate command corresponding to the utterances of the user based on the selected keyword and the selected descriptor pattern.

16. The non-transitory computer-readable medium or media claim 13, wherein the computer-readable instructions, when executed by the at least one processor, cause the at least one processor to, based on determining that dynamic text comprising an ellipsis is displayed on the display screen, obtain a full character string of the dynamic text by iteratively performing OCR to obtain a plurality of character strings for the dynamic text, and concatenate the plurality of character strings.

17. The non-transitory computer-readable medium or media claim 16, wherein the computer-readable instructions, when executed by the at least one processor, cause the at least one processor to iteratively perform OCR only on a region in which the dynamic text is comprised in the display screen.

18. The non-transitory computer-readable medium or media claim 16, wherein the computer-readable instructions, when executed by the at least one processor, cause the at least one processor to concatenate the plurality of character strings based on overlapping portions between two consecutive character strings among the plurality of character strings.
